(19) United States
(12) Patent Application Publication
(10) Pub. No.: US 2005/0059486 A1
(43) Pub. Date: Mar. 17, 2005

(54) Gaming device having an award plate and an indicator plate for displaying selected awards

(76) Inventor: Joseph E. Kaminkow, Reno, NV (US)

Correspondence Address: Bell, Boyd & Lloyd LLC, P.O. Box 1135, Chicago, IL, 60690-1135, US

(21) Appl. No.: 10/941,479

(22) Filed: Sep. 14, 2004

Related U.S. Application Data
(60) Provisional application No. 60/503,025, filed on Sep. 15, 2003.

(51) Int. Cl. A63F 13/00

(52) U.S. Cl. 463/31; 463/16; 463/20

(57) ABSTRACT

A gaming device includes a substantially planar award plate having a plurality of simultaneously displayed award symbols and a substantially planar indicator plate which is positioned in front of the award plate and includes a marker portion. The indicator plate translates in a predetermined path in front of the award plate. When the indicator plate stops moving, the processor chooses one or more award symbols behind the marker portion to illuminate.

### PRIORITY CLAIM

This application is a non-provisional application and claims the benefit of U.S. Provisional Patent Application Ser. No. 60/503,025 filed on Sep. 15, 2003, the entire contents of which are incorporated herein.

### BACKGROUND OF THE INVENTION

It is generally known to provide gaming devices having primary or base games and secondary or bonus games. It is also generally known to provide bonus games or schemes which include a wheel. Such known wheels in the bonus games generally include different credit values on the sections of the wheels. The gaming device also includes an indicator or pointer which indicates or points to one of the credit values on the wheels. At the beginning of the bonus game, the wheel is spun. When the wheel stops spinning, the player is awarded the credits associated with the credit value indicated.

For instance, the Wheel of Fortune gaming device has a set of reels in a slot machine base game. In addition, the gaming device has a wheel having credit values. A player makes a wager which causes the reels of the gaming device to spin. If the player achieves a predetermined condition or combination on the reels, the wheel is activated. The activated wheel may automatically spin or the player may activate a button to cause the wheel to spin. When the wheel stops, a pointer indicates a credit value on the wheel. The player receives the indicated credit value.

To increase player enjoyment and excitement, it is desirable to provide gaming devices having new and different games such as bonus games.

### SUMMARY OF THE INVENTION

In one embodiment, the present invention provides a wagering gaming device having a game with an award plate and an indicator plate. In one embodiment, the game is a bonus game triggered upon an event in a base game. However, the present invention may also be employed in a primary game. In one embodiment, at least one of the plates is moveable relative to the other plate. In another embodiment, both plates are movable.

In one embodiment, the indicator plates and the award plate are planar or are substantially planar. The indicator plate is substantially aligned with the award plate and is in front of the award plate. The award plate includes a plurality of simultaneously displayed symbols, such as award symbols. The indicator plate includes a transversely extending indicator or marker. The marker is see through or clear and is constructed of transparent material. The award plate includes a plurality of symbols, such as award symbols. The gaming device oscillates, moves or rotates at least one of the plates. In one embodiment, at least one of the plates is moveable relative to the other plate. In another embodiment, both plates are movable. In one embodiment, either or both of the plates are flat or are substantially flat.

When a game begins, such as a bonus game, the gaming device oscillates, rotates or translates the indicator plate in a designated direction or along a designated path in front of and relative to the award plate. In one embodiment, one or more of the award symbols of the award plate are sequentially visible through the marker indicator of the indicator plate. The processor selects at least one of the award symbols to indicate. When the indicator plate stops moving, at least one of the award symbols selected by the processor is visible through the marker. In one embodiment, the gaming device provides the player the outcome or award associated with this indicated award symbol.

In another embodiment, the gaming device oscillates the award plate relative to the indicator plate. For example, the indicator plate does not move but the award plate moves or oscillates in a designated direction or along a designated path. When the award plate stops moving, at least one award symbol is visible through the marker. The gaming device provides the player an outcome or award associated with the visible symbol.

In another embodiment, both plates oscillate and then stop oscillating to indicate at least one of the award symbols. The plates move and overlap to causing at least one symbol to be visible through the marker. When both plates stop moving, at least one of the award symbols is visible through the marker. In one embodiment, the gaming device provides the player with an award or outcome based on the designated symbol.

In one embodiment, the plates move at the same time. In another embodiment, the plates move at different times. In one embodiment, the plates move sequentially. In another embodiment, the plates move simultaneously. In one embodiment, the award plate and the indicator plate move in the same direction. In another embodiment, the plates move in different directions. In one embodiment, the indicator plate and the award plate move at the same speed. In another embodiment, the indicator plate and the award plate move at different speeds.

In one embodiment, the award plate and the indicator plate are circular in shape or are wheels. In one embodiment, the award plate and the indicator plate are positioned at the top of the gaming device cabinet with the indicator plate directly in front of the award plate such that the player in front of the gaming device must look through the indicator plate to see the award plate. In one embodiment, the marker of the indicator plate extends substantially transverse from a central point or hub of the indicator plate to the perimeter of the indicator plate. The indicator plate rotates about a central axis at the center or hub of the indicator plate.

When a game, such as a bonus game, begins, the indicator plate begins rotating about the axis. In one embodiment, as the indicator plate rotates, one or more of the award symbols associated with the award plate is randomly selected by the processor. In one embodiment, the award symbols are only visible through the marker of the indicator plate when the marker portion is substantially directly in front of the selected award symbol or symbols. When the indicator plate stops rotating, at least one award symbol of the award plate randomly selected by the processor is illuminated. The selected award symbol is visible through the marker of the indicator plate. The player receives the award associated with this selected award symbol.

In another embodiment, the award plate and the indicator plate are rectangular in shape. The indicator plate is adapted to oscillate or move back and forth relative to the face of the award plate in a substantially horizontal manner. When the bonus game begins, the indicator plate moves back and forth in a substantially horizontal manner. As this occurs, one or more award symbols on the award plate are illuminated and are visible through the marker of the indicator plate. The award symbols are illuminated while aligned with the marker of the indicator plate. When the indicator plate stops moving, one or more award symbols selected by the processor are illuminated. The selected award symbols are visible through the indicator plate. The player receives the award associated with this award symbol.

In another embodiment, the indicator plate oscillates or moves back and forth in a substantially vertical manner.

In one embodiment, the indicator plate provides a similar appearance to a radar screen, wherein the marker illuminates the most recently indicated symbols and causes a fading of the previously indicated symbols.

It is therefore an advantage of the present invention to provide a gaming device having an award plate and an indicator plate which co-act to display one or more of the award symbols.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE FIGURES

FIG. 1 is a perspective view of one embodiment of the gaming device of the present invention.

FIG. 2 is a schematic block diagram of the electronic configuration of one embodiment of the gaming device of the present invention.

FIG. 3 is a front diagrammatic perspective view of the award plate and the indicator plate of one embodiment of the present invention.

FIGS. 4A, 4B, 4C and 4D are fragmentary front elevation views of the indicator plate and the award plate of the embodiment of FIG. 3, illustrating the actuation of the indicator plate.

FIG. 5 is a diagrammatic front perspective view of an award plate and an indicator plate of one alternative embodiment of the present invention.

FIGS. 6a, 6B, 6C and 6D are fragmentary front elevation views of the indicator plate and the award plate of the embodiment of FIG. 5 illustrating the actuation of the indicator plate and award plate.

FIGS. 7A, 7B and 7C are fragmentary front elevation views of a further alternative embodiment of an indicator plate and award plate.

FIGS. 8A, 8B and 8C are fragmentary front elevation views of a further alternative embodiment of an indicator plate and an award plate.

FIGS. 9A and 9B are fragmentary front elevation views of a further alternative embodiment of an indicator plate and an award plate.

### DETAILED DESCRIPTION OF THE INVENTION

### Gaming Device and Electronics

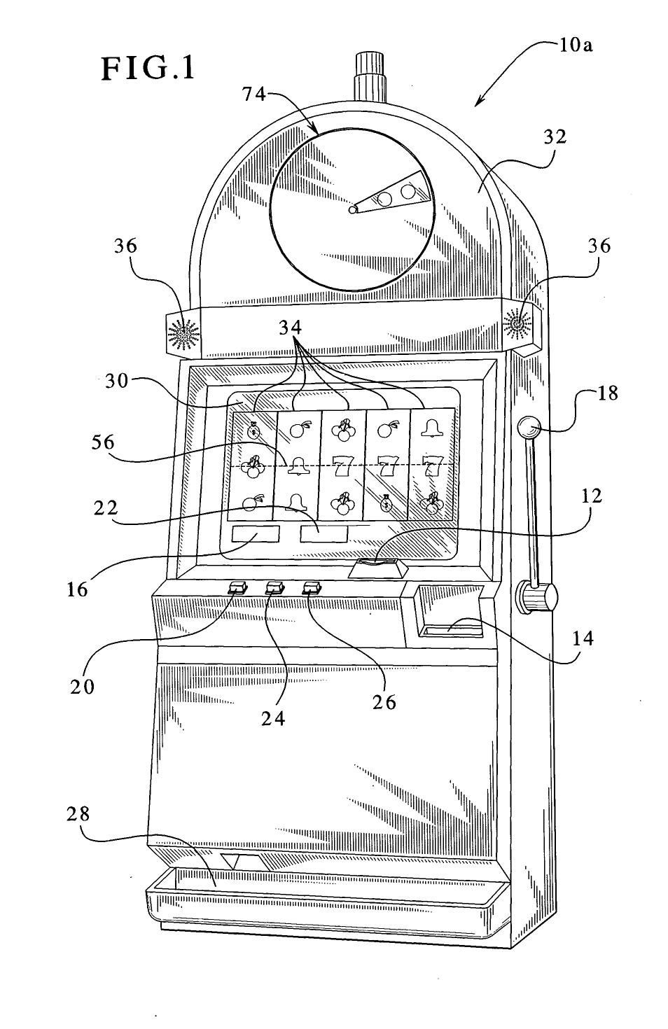

Referring now to the drawings, and in particular to FIG. 1, gaming device 10 illustrates one possible cabinet style and display arrangement. Gaming device 10 can, for instance, be a slot machine having the controls, displays and features of a conventional slot machine, or another game such as a video card game such as video poker. The player can operate the gaming device while standing or sitting. Gaming device 10 also includes being a pub-style or table-top game (not shown), which a player operates while sitting.

The gaming device 10 includes monetary input devices. FIG. 1 illustrates a coin slot 12 for coins or tokens and/or a payment acceptor 14 for cash money. The payment acceptor 14 may also include other devices for accepting payment, such as readers or validators for credit cards, debit cards or smart cards, tickets, notes, etc. When a player inserts money in gaming device 10, a number of credits corresponding to the amount deposited are shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIG. 1, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. A player may cash out by pushing a cash out button 26 to receive coins or tokens in the coin payout tray 28 or other forms of payment, such as an amount printed on a ticket or credited to a credit card, debit card or smart card.

Gaming device 10 also includes one or more display devices. The embodiment shown in FIG. 1 includes a central display device 30. The display device includes any viewing surface such as glass, a video monitor or screen, a liquid crystal display or any other static or dynamic display mechanism. In a video poker, blackjack or other card gaming machine embodiment, the display device includes displaying one or more cards.

The slot machine base game of gaming device 10 displays a plurality of reels such as five reels 34 in mechanical or video form on one or more of the display devices. Each reel 34 displays a plurality of indicia such as bells, hearts, fruits, numbers, letters, bars or other images which preferably correspond to a theme associated with the gaming device 10. If the reels 34 are in video form, the display device displaying the video reels 34 is preferably a video monitor. Each base game, especially in the slot machine base game of the gaming device 10, includes speakers 36 for making sounds or playing music.

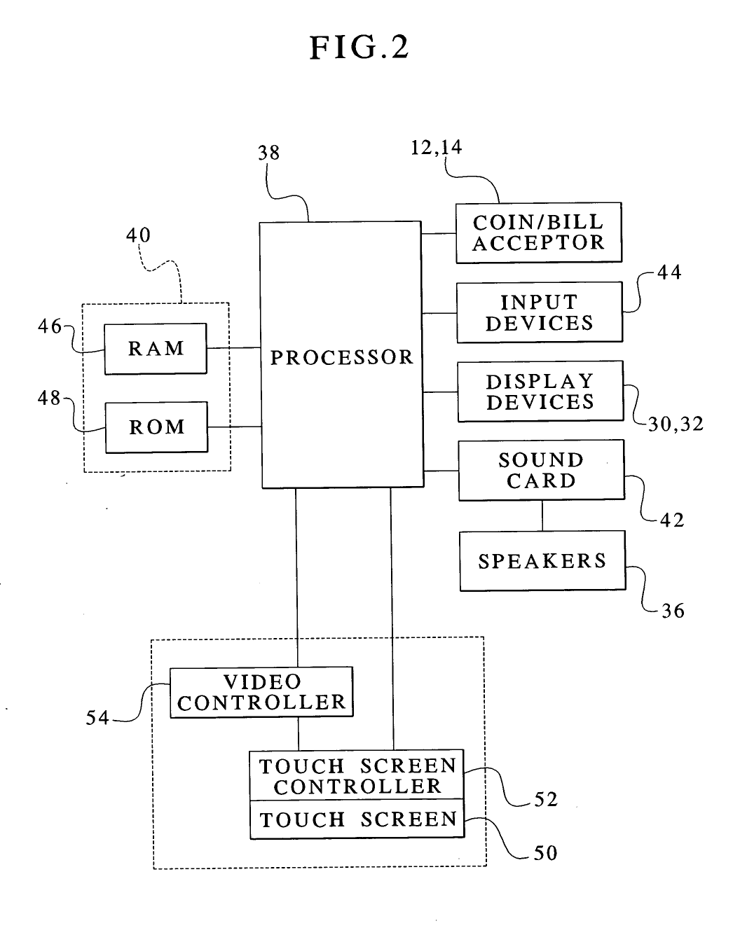

Referring now to FIG. 2, a general electronic configuration of the gaming device 10 for the stand alone and bonus embodiments of the present invention includes: a processor 38; a memory device 40 for storing program code or other data; a central display device 30; an upper display device 32; a sound card 42; a plurality of speakers 36; and one or more input devices 44. The processor 38 is preferably a microprocessor or microcontroller-based platform which is capable of displaying images, symbols and other indicia such as images of people, characters, places, things and faces of cards. The memory device 40 includes random access memory (RAM) 46 for storing event data or other data generated or used during a particular game. The memory device 40 also includes read only memory (ROM) 48 for storing program code, which controls the gaming device 10 so that it plays a particular game in accordance with applicable game rules and pay tables.

As illustrated in FIG. 2, the player uses the input devices 44 to input signals into gaming device 10. In the slot machine base game, the input devices 44 include the pull arm 18, play button 20, the bet one button 24 and the cash out button 26. A touch screen 50 and touch screen controller 52 are connected to a video controller 54 and processor 38. The terms “computer” or “controller” are used herein to refer collectively to the processor 38, the memory device 40, the sound card 42, the touch screen controller and the video controller 54.

In certain instances, it is preferable to use a touch screen 50 and an associated touch screen controller 52 instead of a conventional video monitor display device. The touch screen enables a player to input decisions into the gaming device 10 by sending a discrete signal based on the area of the touch screen 50 that the player touches or presses. As further illustrated in FIG. 2, the processor 38 connects to the coin slot 12 or payment acceptor 14, whereby the processor 38 requires a player to deposit a certain amount of money in to start the game.

It should be appreciated that although a processor 38 and memory device 40 are preferable implementations of the present invention, the present invention also includes being implemented via one or more application-specific integrated circuits (ASIC's), one or more hard-wired devices, or one or more mechanical devices (collectively and/or alternatively referred to herein as a “processor”). Furthermore, although the processor 38 and memory device 40 preferably reside in each gaming device 10 unit, the present invention includes providing some or all of their functions at a central location such as a network server for communication to a playing station such as over a local area network (LAN), wide area network (WAN), Internet connection, microwave link, and the like.

With reference to the slot machine base game of FIG. 1, to operate the gaming device 10, the player inserts the appropriate amount of tokens or money in the coin slot 12 or the payment acceptor 14 and then pulls the arm 18 or pushes the play button 20. The reels 34 then begin to spin. Eventually, the reels 34 come to a stop. As long as the player has credits remaining, the player can spin the reels 34 again. Depending upon where the reels 34 stop, the player may or may not win additional credits.

### Co-Acting Indicator and Symbol Plates

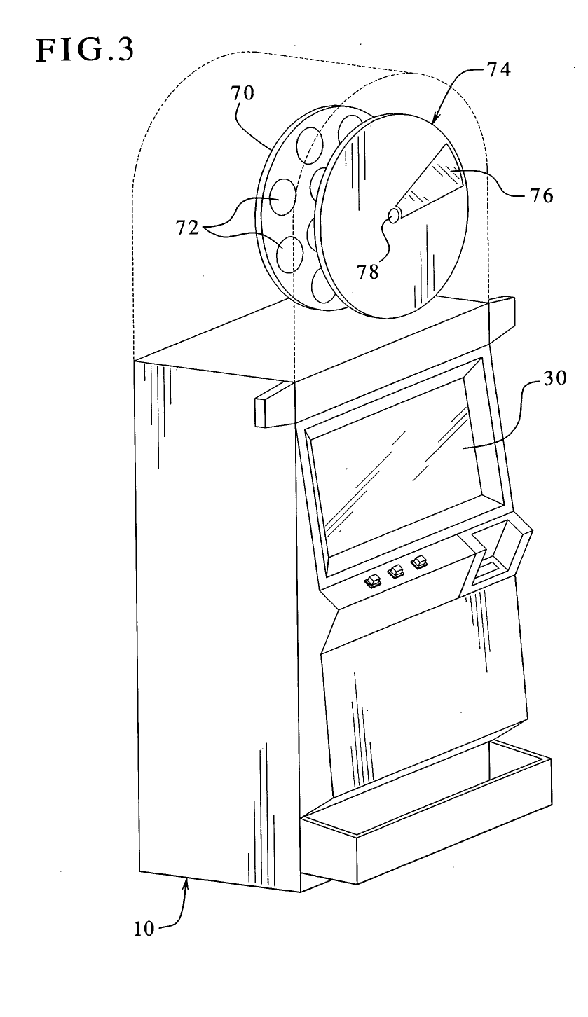

Referring now to FIG. 3, in one embodiment, the gaming device includes a first plate or symbol plate such as an award plate 70 and a second plate or indicator plate 74. The first plate includes at least one symbol. The second plate includes a marker portion which is see-through or clear. In one embodiment, at least one of the plates moves and stops moving to indicate at least one of the symbols on the award plate. The gaming device provides the player with an award based on the indicated symbol.

As illustrated in FIG. 3, in one embodiment, the award plate 70 is suitably mounted to the cabinet of the gaming device. In one embodiment, the award plate is circular and flat. It should be appreciated that the award plate may be any suitable shape and have any suitable curvature. The award plate includes one or more symbols such as award indicators or award symbols 72. The award symbols 72 are positioned at various locations on the award plate. The award symbols may represent different awards, award values, credit symbols, free game symbols, or any suitable game outcome or award value. It should be appreciated that the award symbols may be used in conjunction with a primary game or secondary game, free game symbols, credit symbols or any other suitable symbols.

A second plate or indicator plate 74 is suitably mounted to the cabinet of the gaming device. In the illustrated embodiment, the indicator plate is circular and flat. It should be appreciated that the indicator plate may be any suitable shape and have any suitable degree of curvature. In this embodiment, the indicator plate is positioned fully and directly in front of the award plate 70. In another embodiment, the indicator plate is positioned partially or in substantial alignment with the award plate.

The indicator plate 74 includes a marker or marker portion 76. In one embodiment, the marker portion is see-through or clear and is constructed of transparent material. It should be appreciated that the marker portion may be constructed of any suitable type of material. In one embodiment, the marker portion is transparent. In one embodiment, the non-marker portion of the indicator plate 74 is translucent. In one embodiment, the indicator plate 74 is suitably mounted to rotate about an axis extending through the center or hub 78 of the indicator plate 74. In one embodiment, the award plate 70 is also suitably mounted to rotate about an axis extending through the center or hub of the award plate. In one embodiment, these axes are the same. In one embodiment, the award plate and the indicator plate are supported by suitable supports (not shown).

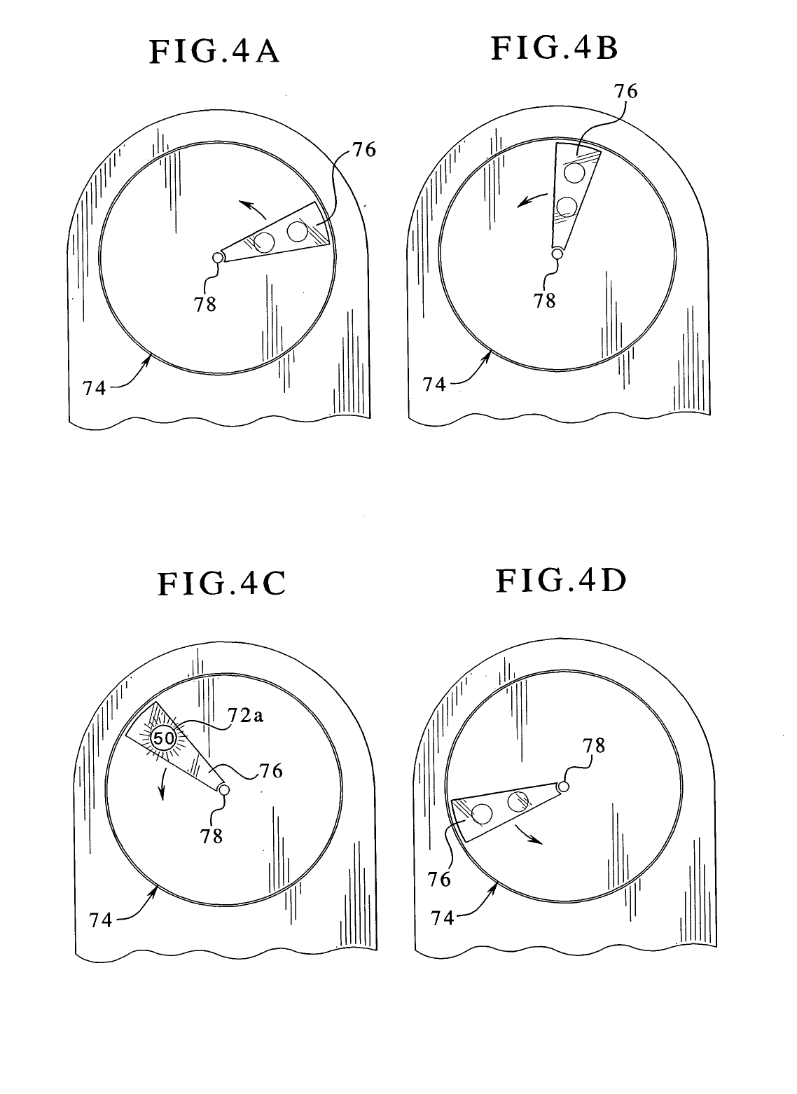

In one embodiment, the award plate 70 and the indicator plate are aligned such that the award plate is not seen from the front of the gaming machine. In one embodiment, when a bonus round begins, the indicator plate begins rotating about the axis, as generally illustrated in FIGS. 4A to 4D.

In one embodiment, the indicator plate rotates in a counter-clockwise direction, as illustrated in FIG. 4A to 4D. As the indicator plate 74 rotates or oscillates, the processor causes one or more award symbols on the award plate to illuminate as the marker portion passes in front of those award symbols. As illustrated in FIG. 4C, the gaming device illuminates an award symbol 72a only during the time the marker portion passes in front of the award symbol 74. The award symbol is no longer illuminated when the marker portion passes the award symbol as seen FIG. 4D.

In one embodiment, when the indicator plate stops rotating, the processor illuminates one or more of the selected award symbols positioned behind the marker portion. This illumination enables to player to view the selected award symbols. In one embodiment, the gaming device awards the player the award or award amount associated with all of these indicated award symbols. The award symbols may be illuminated before, during or after being indicated by the marker. In another embodiment, as the symbols are indicated by the marker, the illumination of the symbols change. That is, the symbols viewed through the marker may be illuminated such that none, one, a plurality or all of the symbols are illuminated. In one embodiment, if the marker stops on a plurality of symbols, the illuminated symbols determine the outcome or award for the player.

In another embodiment, the award plate and the indicator plate both rotate or oscillate. In one embodiment, the plates oscillate sequentially. In another embodiment, the plates oscillate simultaneously. In one embodiment, the plates move in different directions. In one embodiment, the indicator plate and the award plate move at the same speed. In another embodiment, the indicator plate and the award plate move at different speeds.

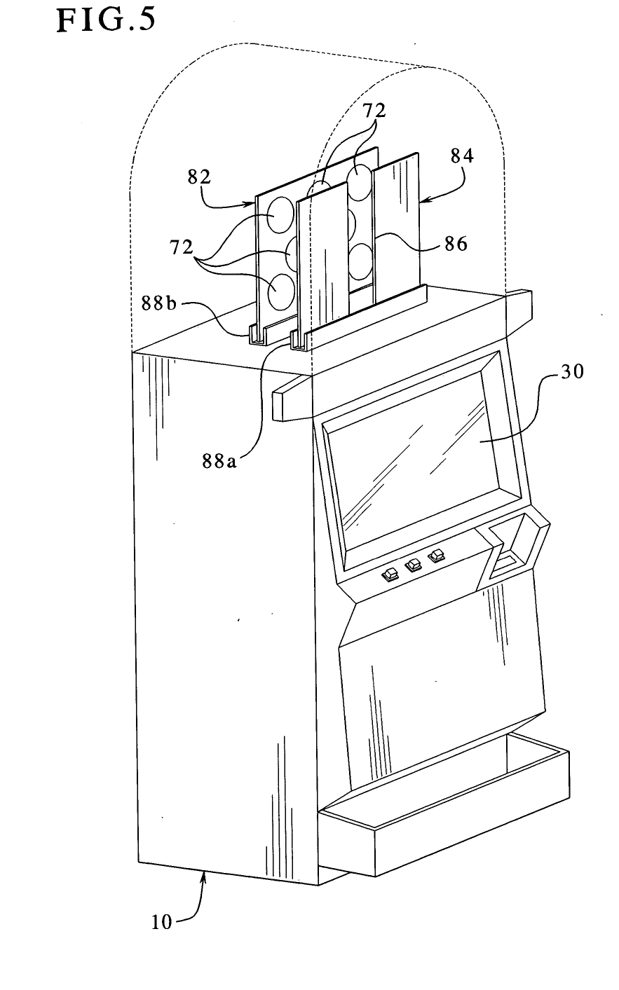

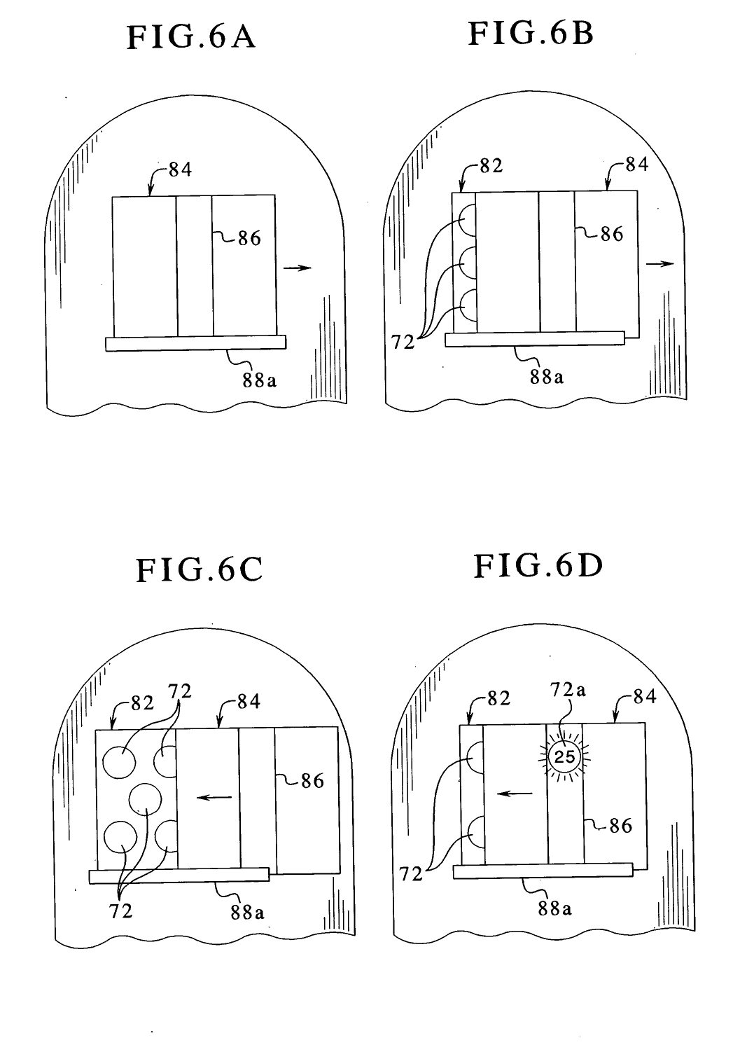

In another embodiment, the award plate 82 and the indicator plate 84 each are rectangular as generally illustrated in FIG. 5. The flat award plate includes a plurality of award symbols 72 positioned at various locations on the award plate in a manner similar to that described above. The flat indicator plate includes a marker portion. It should be appreciated that the plates may have any amount or degree of slope or curvature. In one embodiment, the indicator plate 84 includes a marker portion 86 that extends from the top of the face of the indicator plate to the bottom of the face of the indicator plate as illustrated in FIGS. 6A, 6B, 6C and 6D. The award plate and the indicator plate are positioned on suitable tracks such as tracks 88a and 88b which secure the award plate and indicator plate. These tracks enable either plate to be moved along the top of the gaming device in a substantially horizontal manner.

FIGS. 6A to 6D illustrate the indicator plate 84 oscillating or moving back and forth in a substantially horizontal manner relative to the award plate. As illustrated in FIG. 6D, in one embodiment, the processor illuminates one or more of the award symbols 72a on the award plate as the indicator plate oscillates. In one embodiment, the processor illuminates the award symbol when the marker portion is positioned in front of that award symbol. Once the marker portion is no longer in front of the illuminated award symbol, the processor ceases illumination of the award symbol, and the indicator plate appears in a state similar to that shown by FIG. 6C. Various different methods for illuminating and indicating award symbols can be employed with this embodiment.

It should be appreciated that either the award plate, the indicator plate or both the award plate and indicator plate may oscillate. In one embodiment, the plates oscillate in different directions and overlap at the same period in time to indicate one or a plurality of the symbols with the marker portion.

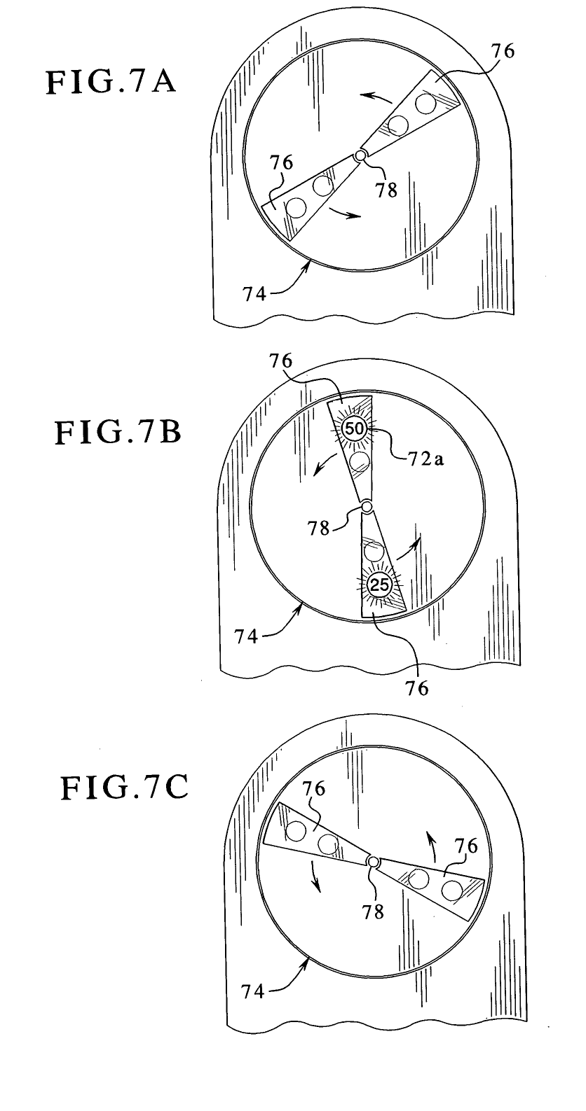

In one alternative embodiment, the indicator plate 74A is circular in shape and the marker portion 76 extends along a diameter of the indicator plate, as illustrated in FIGS. 7A, 7B and 7C. The bonus game is played in a manner similar to that described above, whereby the indicator plate rotates or oscillates. The processor selects one or more of the award symbols. The processor causes the illumination of one or more award symbols such as award symbols 72a and 72b on the award plate as the marker portion passes in front of the award symbol or symbols, as seen in FIG. 7B. That is, the gaming device illuminates at least one of the award symbols when it is directly behind the marker portion. In one embodiment, the indicator plate or plates stop moving to indicate at least one of the selected symbols. In one embodiment, the gaming device provides a player with the awards associated symbol indicated when the award plate stops moving. In one embodiment, the symbols are numerals and the gaming device provides the player with the amount of the indicated symbol. In another embodiment, the gaming device provides a player with an award associated with each indicated symbol.

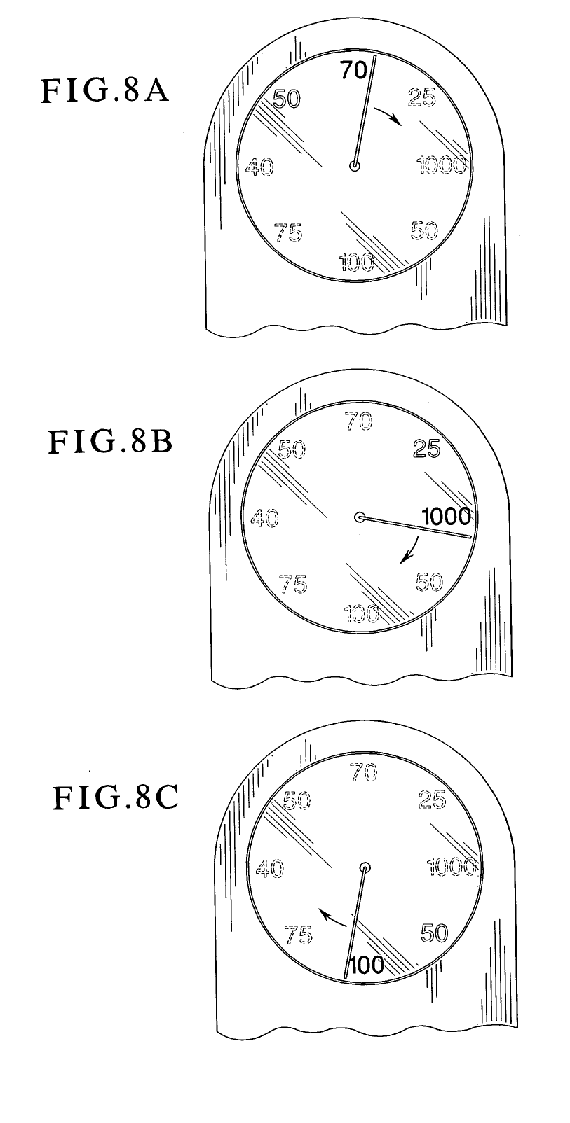

As illustrated in FIGS. 8A to 8C, an alternative embodiment of the present includes an award plate 90 and a marker 92. The marker moves in relation to the award plate. As the marker moves over or passes a symbol, the symbol becomes visible. As the marker moves away from the visible symbol, the symbol is not visible or the symbol fades out as illustrated in FIGS. 8A to 8C. For example, in FIG. 8A, as the marker 92 passes the 70 symbol, the gaming device illuminates the 70 symbol. As illustrated in FIG. 8B, As the marker continues to move in a clockwise direction the 70 symbol fades or dims. As the marker moves, the gaming device illuminates the 25 symbol and then the 1000 symbol. It should be appreciated that the marker may move in any direction. In one embodiment, the gaming device provides the player with an outcome based on the symbol indicated when the marker stops moving.

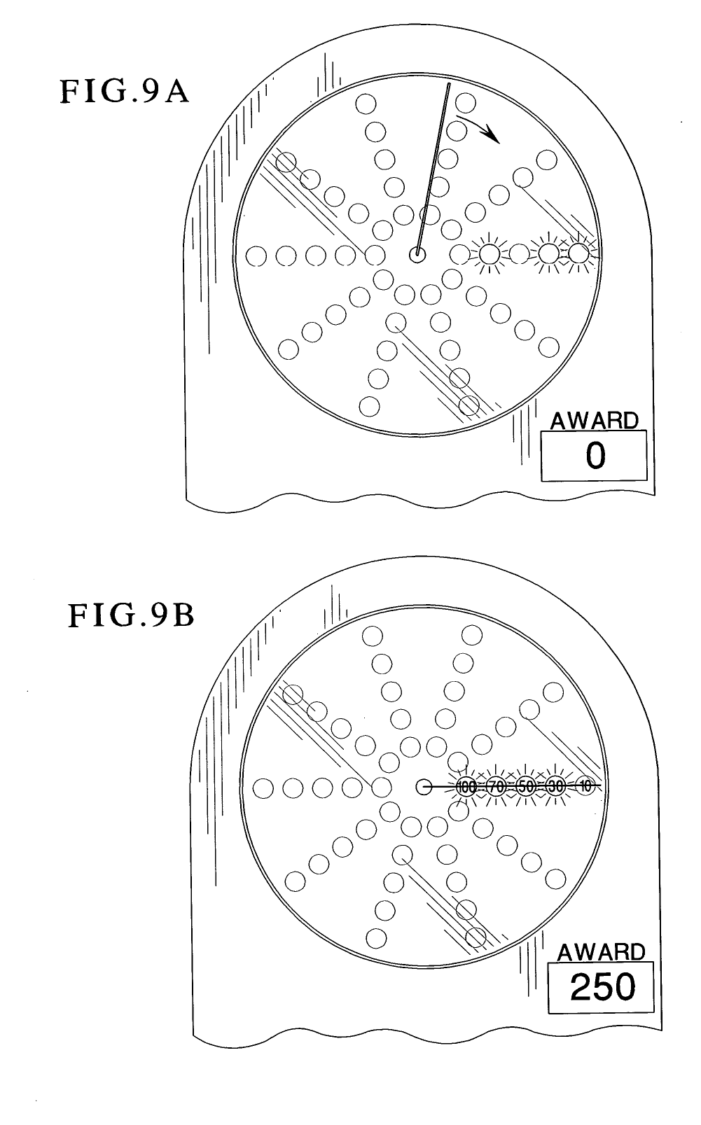

Referring now to FIGS. 9A and 9B, the marker 92 of the indicator plate 90 is adapted to move simultaneously over a plurality of symbols such as award symbols 72 at the same time. The symbols are adapted to be illuminated at various times. As illustrated in FIG. 9A, a plurality of different award symbols in the same row are illuminated. The illumination of the symbols may change before or during the indication of the symbols by the marker. When the marker stops on a plurality of award symbols, the illuminated symbols determine the award. Thus, as illustrated in FIG. 9B, the award provided to the player is two hundred fifty, which is the sum of the awards associated with the illuminated award symbols. It should be appreciated that while the marker 92 is illustrated as a straight line, the marker could be carved, angled, in a zig-zag pattern or any suitable shape.

In one embodiment, after the marker stops moving or rotating, the indicated or illuminated symbols change. For example, when the marker stops on a plurality of symbols, only one of the award symbols is illuminated. The gaming device then illuminates another of the symbols indicated by the marker. In another embodiment, the gaming device illuminates at least one of the symbols and then illuminates at least one other symbol. The gaming device may illuminate a first symbol, stops illuminating that symbol and illuminates a different symbol. In this embodiment, the symbols which are illuminated after the changing of the illumination terminates determine the award provided to the player.

It should be appreciated that the shapes of the award plate and indicator plate are not limited to the examples described above. The award plate and the indicator plate may be any suitable shape. The marker portion of the indicator plate may be any suitable material. The marker portion may be any suitable material that enables a player to view the award symbols through it. It should also be appreciated that the shapes of the award plate and indicator plate may be independent of each other. It should further be appreciated that the type of movement of the indicator plate is not limited to the examples described above, but may be in any direction and for any duration of time. It should be appreciated that the award plate may also be designed to move in any direction and for any duration of time. The award plate may move in a path dependent or independent of the path in which the indicator plate moves. It should also be appreciated that shape of the marker portion is not limited to the above examples, but may be any shape allowing the display of award symbols. It should be further appreciated that the award plate and indicator plate may be provided in virtual form on the display device of the present invention.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

1. A gaming device operated under the control of a processor, said gaming device comprising:
a cabinet;
a game controlled by the processor and operable upon a wager by a player, said game mounted in said cabinet;
a substantially planar award plate supported by the cabinet, said award plate including a plurality of simultaneously displayed award symbols;
a substantially planar indicator plate supported by the cabinet in front of and in substantial alignment with said award plate, wherein at least one of the award plate and the indicator plate is operable to move in a predetermined path relative to the other plate to indicate at least one of said award symbols, wherein said indicator plate defines a marker portion which is operable to simultaneously indicate a plurality of said award symbols; and
an award provided to the player based on at least one of said plurality of indicated award symbols.

2. The gaming device of claim 1, wherein said marker portion is transparent.

3. The gaming device of claim 1, wherein at least one of the award plate and the indicator plate are operable to translate relative to the other plate.

4. The gaming device of claim 1, wherein the award is based on a plurality of said award symbols simultaneously indicated by the marker portion of the indicator plate.

5. A gaming device operated under the control of a processor, said gaming device comprising:
a cabinet;
a game controlled by the processor and operable upon a wager by a player, said game mounted in said cabinet;
a first substantially planar plate connected to the cabinet having a plurality of simultaneously displayed award symbols; and
a second substantially planar plate connected to the cabinet, said second plate having a marker portion, said second plate positioned substantially in front of said first plate such that the award symbols can be viewed through said marker portion,
wherein said processor is operable to cause said marker portion of said second plate to simultaneously indicate a plurality of said award symbols and to provide an award to the player based on at least one of the indicated award symbols.

6. The gaming device of claim 5, wherein the processor is operable to cause the second plate to oscillate relative to the first plate and wherein the marker portion indicates said award symbols when the second plate stops moving.

7. The gaming device of claim 5, wherein the processor is operable to cause the first plate to oscillate relative to said second plate and wherein the marker portion indicates said award symbols when the first plate stops moving.

8. The gaming device of claim 5, wherein the processor is operable cause the second plate to translate relative to the first plate and wherein the marker portion indicates said plurality of award symbols when the second plate stops moving.

9. The gaming device of claim 5, wherein the processor is operable to cause the first plate to translate relative to said second plate and wherein the marker portion indicates said award symbols when the first plate stops moving.

10. The gaming device of claim 5, wherein the processor is operable to cause the illumination of at least one of the indicated award symbols.

11. The gaming device of claim 5, wherein the marker portion is substantially transparent.

12. The gaming device of claim 5, wherein the processor is operable to cause both the first plate and the second plate to move.

13. A gaming device operated under the control of a processor, said gaming device comprising:
a game controlled by the processor and operable upon a wager by a player;
a substantially planar award plate including a plurality of simultaneously displayed award symbols; and
a substantially planar indicator plate, said indicator plate positioned substantially in front of said award plate, wherein said indicator plate defines a marker portion,
wherein said processor is operable with said indicator plate and said award plate to:
(a) move at least one of the award plate or the indicator plate,
(b) simultaneously indicate a plurality of the award symbols when the award plate and the indicator plate stop moving, and
(c) provide an award to the player based on at least one of said indicated award symbols.

14. The gaming device of claim 13, wherein the award plate is circular.

15. The gaming device of claim 13, wherein the indicator plate is circular.

16. The gaming device of claim 13, wherein the processor is operable to cause the indicator plate to oscillate relative to the award plate and to cause the marker portion to indicate said award symbols when the indicator plate stops moving.

17. The gaming device of claim 13, wherein the processor is operable to cause illumination of at least one of the indicated award symbols when said award symbol is in substantial alignment with said marker portion.
